(19) United States
(12) Patent Application Publication
(10) Pub. No.: US 2007/0016399 A1
(43) Pub. Date: Jan. 18, 2007

(54) Method and apparatus for detecting data anomalies in statistical natural language applications

(75) Inventors: Yuqing Gao, Mount Kisco, NY (US); Hong-Kwang Jeff Kuo, Pleasantville, NY (US); Roberto Pieraccini, Peekskill, NY (US); Jerome L. Quinn, North Salem, NY (US); Cheng Wu, Mount Kisco, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/179,789

(22) Filed: Jul. 12, 2005

(51) Int. Cl. G06F 17/28

(52) U.S. Cl. 704/5

(57) ABSTRACT

Techniques for detecting data anomalies in a natural language understanding (NLU) system are provided. A number of categorized sentences, categorized into a number of categories, are obtained. Sentences within a given one of the categories are clustered into a number of sub clusters, and the sub clusters are analyzed to identify data anomalies. The clustering can be based on surface forms of the sentences. The anomalies can be, for example, ambiguities or inconsistencies. The clustering can be performed, for example, with a K-means clustering algorithm.

### FIELD OF THE INVENTION

The present invention relates to natural language techniques, and, more particularly, relates to the detection of data anomalies, such as ambiguities and/or inconsistencies, in natural language applications.

### BACKGROUND OF THE INVENTION

In a natural language understanding (NLU) system, such as a call center, the system logic, such as the call routing or call flow logic, changes over time. In automated call handling information technology solutions for call centers, definitions may be changed over the course of a project life cycle. Manual labeling of data, a technique which is commonly employed, is expensive. Where different human annotators work on different parts of the data, data inconsistency may result, which can harm the accuracy of the resulting statistical NLU system. Furthermore, inherently ambiguous sentences may span multiple categories and need to be addressed at design and run time.

Heretofore, there has been a reliance on human operators to detect data anomalies such as ambiguities and inconsistencies. Such human intervention is expensive and potentially inaccurate.

In view of the foregoing, there is a need in the prior art for techniques to detect data anomalies in NLU systems wherein costs can be lowered, accuracy and/or performance can be improved, and/or the need for human intervention can be reduced or eliminated.

### SUMMARY OF THE INVENTION

Principles of the present invention provide techniques for detecting data anomalies in an NLU system. An exemplary method of detecting data anomalies in an NLU system, according to one aspect of the present invention, includes obtaining a plurality of categorized sentences that are categorized into a plurality of categories, clustering those of the sentences within a given one of the categories into a number of subclusters, and analyzing the subclusters to identify data anomalies in the subclusters. The clustering can be based on surface forms of the sentences, that is, based on what a customer or other user actually stated, as opposed to an estimate of what the customer meant. The data anomalies can include data ambiguities and data inconsistencies.

One or more exemplary embodiments of the present invention can include a computer program product and/or an apparatus for detecting data anomalies in an NLU system that includes a memory and at least one processor coupled to the memory that is operative to perform method steps in accordance with one or more aspects of the present invention.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a high-level flow chart depicting an exemplary method of detecting data anomalies according to one aspect of the present invention;

FIG. 2 is a detailed flow chart showing steps that could correspond to block 106 in FIG. 1;

FIG. 3 is a detailed flow chart showing seeding steps that could correspond to block 114 of FIG. 1;

FIG. 4 is a detailed flow chart showing an exemplary implementation of a K-means procedure that could correspond to blocks 116-120 of FIG. 1;

FIG. 5 is a flow chart depicting detailed analysis steps that could correspond to blocks 122 and 124 of FIG. 1;

FIG. 6 shows an exemplary graphical user interface, according to an aspect of the present invention, displaying information associated with a detected data anomaly;

FIG. 7 shows detailed information that may be displayed by a graphical user interface according to an aspect of the present invention responsive to a user mouse-clicking on the pertinent portion of FIG. 6; and

FIG. 8 depicts an exemplary computer system which can be used to implement one or more embodiments of the present invention.

### DETAILED DESCRIPTION OF PREFERRED EMBODIMENTS

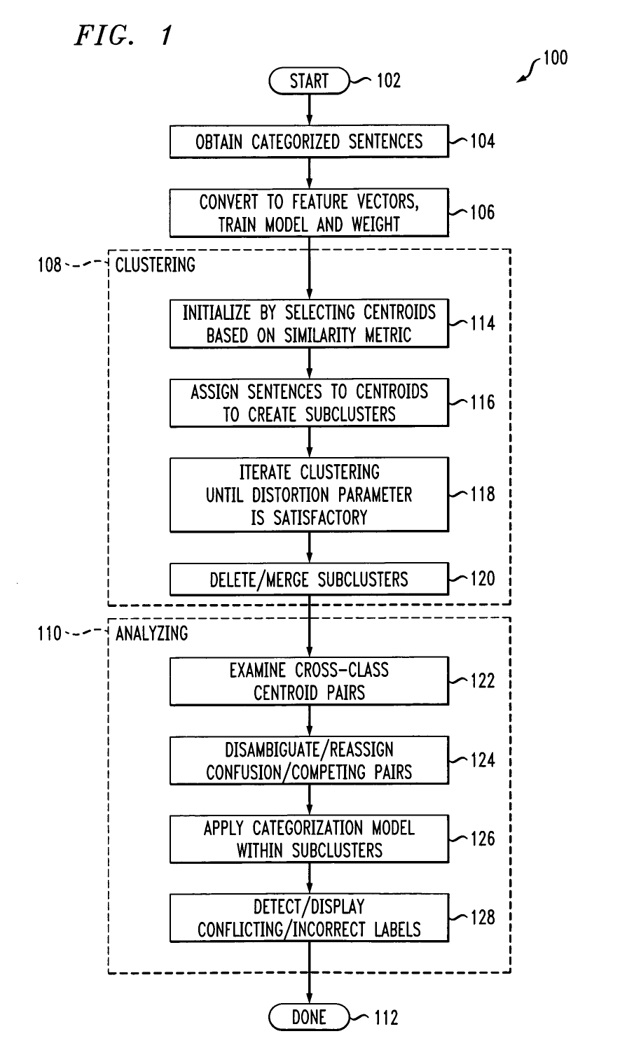

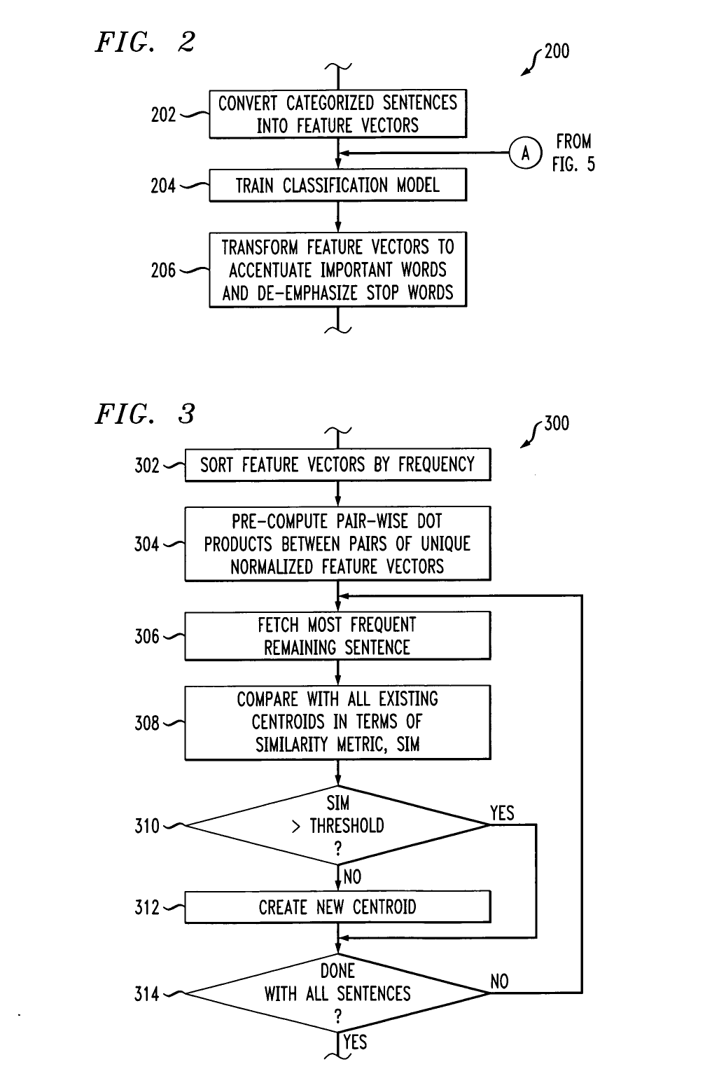

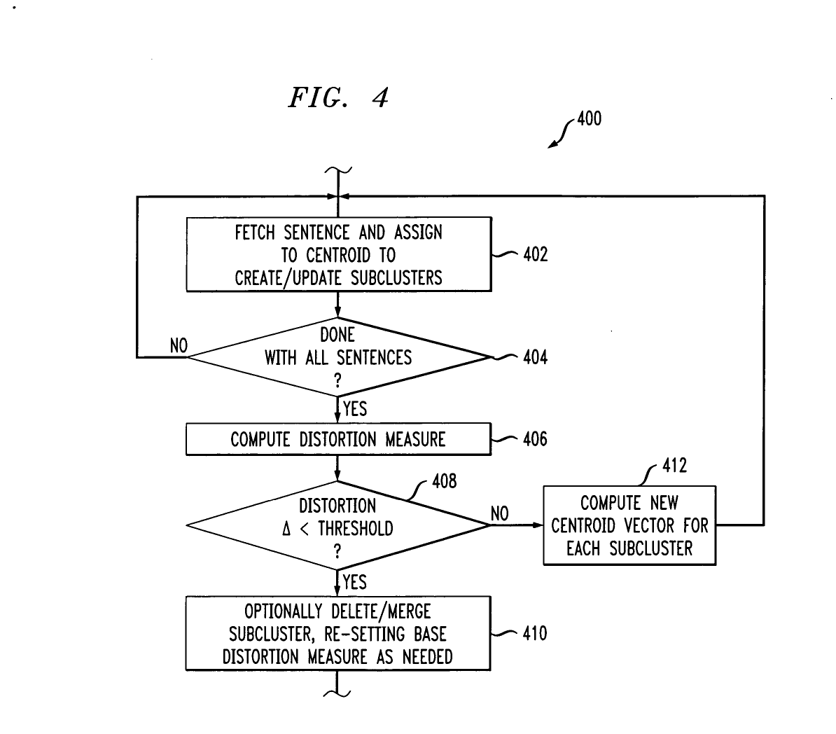

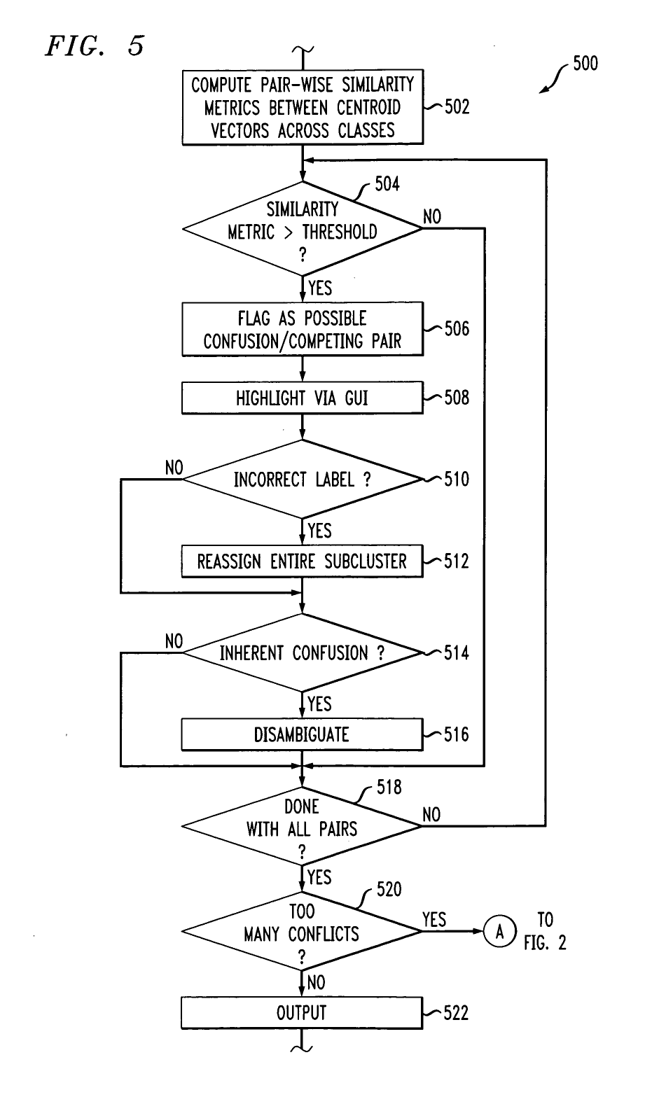

Attention should now be given to FIG. 1, which presents a flow chart 100 of an exemplary method (which can be computer-implemented), in accordance with one aspect of the present invention, for detecting data anomalies in an NLU system. The start of the method is indicated by block 102. The method can include the steps of obtaining a number of categorized sentences that are categorized into a number of categories, as indicated at block 104. The categorized sentences may have been categorized by humans, semi-automatically, completely automatically, or in some combination thereof; for example, an iterative application of exemplary methods according to the present invention can be employed. The method can also include the step of clustering those of the sentences within a given one of the categories into a number of subclusters, as at block 108. Further, the method can include the step of analyzing the subclusters to identify data anomalies that may be present, as indicated at block 110. With regard to block 104, it should be noted that the sentences need not be complete grammatical sentences; phrases and fragments (and even single words and/or silence, when meaning is conveyed thereby) are also included within the meaning of “sentences” as used herein (including the claims). As indicated at block 106, in one or more embodiments of the present invention, the sentences can be converted to feature vectors, an appropriate classification model can be trained based on training data, and appropriate weighting can be applied to accentuate important words or features while de-emphasizing un-important words such as “stop” words (e.g., “a,” “the,” and the like). Further details regarding potential implementations of block 106 are discussed below with respect to FIG. 2.

In the clustering step 108, the clustering can be based on surface forms of the sentences. A “surface form” is what the person (such as a user, broadly including a customer, system operator, IT professional, application developer, and the like) interfacing with the NLU system actually said or otherwise input, as opposed to the use of a tag to model a sentence. In prior techniques where a tag is used to model a sentence, instead of operating based on surface forms, one is proceeding based on an estimate of what one thinks the person meant when they spoke or otherwise interacted with the NLU system. Thus, in one or more embodiments of the present invention, clustering may be based on surface forms rather than, for example, initial class labels or semantics.

The clustering step 108 can include a number of sub-steps, and can be performed, for example, with a K-means clustering algorithm. In the exemplary embodiment represented in FIG. 1, the subclusters are represented by centroids (important words with weights). In other embodiments of the invention, subclusters might be represented, for example, by canonical sentences. A prototypical or canonical sentence is a sentence that is most similar to every other sentence, on average. Where the sentences are converted to feature vectors, as discussed with regard to block 106, such conversion process can be envisioned as being part of the clustering process 108. Thus, the aforementioned clustering sub-steps can include modeling each of the sentences as a feature vector and then creating a new centroid model for each feature vector that differs by more than a specified amount from any existing centroid models. That is, as shown at block 114, one can perform an initialization process by selecting centroids based on a similarity metric. One could, for example, designate the first feature vector examined as a centroid, and then, for each subsequent feature vector, one can examine the subsequent feature vectors to see if they are sufficiently close to the existing centroid. If yes, they are not designated as new centroids, while if not sufficiently close, they would be designated as new centroids.

Once centroids have been generated, further steps can include assigning each of the sentences to a pre-existing centroid that corresponds to a given subcluster, as shown at block 116. One can then compute an appropriate distortion measure, and, responsive to a change in the distortion measure being at least equal to a threshold value, one can conduct an initial iteration of the assigning and computing steps. This is indicated at block 118, where it is shown that one can iterate the clustering process until a distortion parameter is satisfactory (for example, the distortion parameter could be some change in the aforementioned distortion measure, and once the change was small enough, one could stop the iteration process).

Clustering can be based on a unique distance metric that is itself based on the statistical classifier trained from the initial labeling of the data. This allows important words and features to be accentuated, and the less important ones to be essentially ignored. These less important words can be the aforementioned “stop” words; however, the stop words would not necessarily need to be manually specified, rather, the appropriate de-weighting is inherent in the clustering process. That is, each component in a given feature vector can be pre-weighted using the appropriate maxent (maximum entropy) model parameter. This pre-weighting automatically reduces the influence the aforementioned “stop” words and no manual selection of stop words is necessary.

Deletion and/or merging of subclusters can be conducted as indicated at block 120. For example, an appropriate quantity criteria can be specified and the number of sentences clustered into a given one of the subclusters can be checked against the quantity criteria. If the quantity criteria is violated, the sentences can be reassigned to another subcluster, e.g., if a subcluster has too few sentences contained within it, its sentences can be assigned to another one of the subclusters. Note that “sentences” is used interchangeably with “feature vectors” to refer to feature vectors corresponding to given sentences, once the vectorization has taken place.

In the analyzing step 110, any desired type of data anomaly can be detected. Such anomalies can include, for example, data ambiguities and/or data inconsistencies. An example of a data ambiguity might occur when a system user, such as a caller to an NLU call center, mentions the words “delivery on Saturday.” This statement may be ambiguous. For example, it may refer to an inquiry regarding whether delivery on Saturday would be possible for an order placed today. On the other hand, it may refer to an inquiry regarding why a previously-placed gift order did not arrive on Saturday. A data inconsistency may occur, for example, when interactions containing certain key words were first routed to a first subcluster but, due to a change in underlying logic, are now routed to a second subcluster. Therefore, there may be two different subclusters each having similar sentences associated therewith.

Analyzing step 110 can include one or more sub-steps. In general, the analysis of the subclusters to identify the data anomalies can include cross-class analysis or analysis within given subclusters. For example, when the subclusters are formed with respect to the aforementioned centroids, one can examine cross-class centroid pairs as at block 122. Such examination can involve determining at least one parameter (such as a similarity parameter to be discussed below) associated with the pairs of centroids. Where competing pairs are detected (as in the above example of data inconsistency), the sentences in a given subcluster can be reassigned to the correct, competing, subcluster. Thus, in one or more embodiments of the present invention, one can conveniently reassign all sentences in a given subcluster to the correct subcluster, as a group, in a single action. Accordingly, selected sentences (such as those in an incorrect competing subcluster) can essentially be relabeled on a subcluster basis as opposed to a sentence-by-sentence basis, responsive to the identification of the data anomaly.

When the examination of cross-class centroid pairs in block 122 indicates ambiguity, as described above, appropriate disambiguation can be conducted for the confusion pairs. Thus, in the case of confusion pairs, a first group of sentences may fall within a first class and a second group of sentences, with surface forms similar to those of the first group, may fall within a second class. One can then form a new set, such as a new subcluster appropriate to both the first and second groups of sentences, and an appropriate disambiguation dialog can be developed to disambiguate between the first and second groups of sentences. Such actions would apply to the above-mentioned example regarding “delivery on a Saturday.” A disambiguation dialog could be machine-generated, or one could prompt an operator to enter data representative of a suitable disambiguation dialog, and such data could then be obtained by the NLU system and used in future user interactions when the confusing utterance/statement was encountered. Thus, an NLU system employing one or more aspects of the present invention could prompt an operator (or other appropriate user) to construct the disambiguation dialog, and could receive appropriate data representative of such dialog from the operator.

The categorized sentences obtained at block 104 would typically be categorized according to a categorization model. As indicated at blocks 126-128, one could apply the categorization model to sentences within a given one of the subclusters in order to obtain model results, and one could then analyze the results to determine the presence of conflicting and/or potentially incorrect labeling. One may advantageously hold back some data during initial training of the model, and may use the held-out data for an appropriate test set. Thus, model over training can be avoided. Such hold-out or hold-back of some training data for test purposes can be conducted in a “round robin” fashion. For example, 90% of a given set of data can be used for training, with 10% saved for test purposes. A comparison can then be performed, and then a different 90% can be used for training and a different 10% saved for test purposes. Stated differently, one could divide a set of data into ten blocks numbered from one to ten. Block 1 could be held out for testing, while training on blocks 2-10. Then, one could hold block 2 back for testing, and train on blocks 1 and 3-10, and so on.

It will be appreciated that the sentences might be in the form of tagged text and may have their origin either in speech, for example, utterances in an audio file processed with an automatic speech recognition system, or may have been obtained directly as text, for example, through a web interface. The sentences can be tagged with a class name, that is, one of the aforementioned categories, which can be a destination name in the case of a call routing system. A category is essentially used synonymously with a class. As noted, the categories/classes can be manually defined destinations or tags. The aforementioned subclusters constitute smaller groups within a given category or class.

Block 112 indicates completion of a pass through the process depicted in flow chart 100.

Turning now to FIG. 2, a flow chart 200 depicts detailed method steps that could be used to perform the functions of block 106, in one or more exemplary embodiments of the present invention. At block 202, categorized sentences can be converted into feature vectors. At block 204, a classification model can be trained. At block 206, the feature vectors can be transformed to accentuate important words and to de-emphasize stop words. Item A indicates a point where iterations can be started and will be discussed further below with regard to FIG. 5. The aforementioned categorized sentences can be thought of as a form of labeled training data, which can be converted into feature vectors in the form of a vector space model. Each sentence can be converted into a feature vector v. The parameter v[i] is equal to the number of occurrences of feature i in the given sentence. Feature vectors are typically sparse, that is, the parameter v[i] is equal to zero for many i. Examples of features fᵢ include, for example, words, word pairs, word triplets, word collocations, semantic-syntactic parse tree labels, and the like. In one or more exemplary embodiments of the invention, the features can be limited to word features for purposes of simplicity. The training of the classification model in block 204 can be performed based on the aforementioned training data and can be conducted, for example, using a maximum entropy model. The parameters of the maximum entropy model are associated with pairs of features and classes, λ(fᵢ, cₖ), where fᵢ are the aforementioned features and cₖ are the classes.

With regard to block 206, the feature vectors can be transformed into a different vector space where semantically important words/features for the given classification task are accentuated, while unimportant words, such as the aforementioned stop words can be automatically under-weighted. The transformation process, may, for example, proceed as follows: for each sentence with corresponding class label cₖ, for each feature fᵢ:
v′[i]=v[i]λ(fᵢ, cₖ) (1)
One can then normalize the feature vectors to be unit length:
\hat{v}[i]=v′[i]/∥v′∥, where ∥v′∥=\sqrt{Σᵢv′[i]²} (2)
These normalized feature vectors can be used for all further processing. In the following description, a sentence is synonymous with the feature vector that represents the sentence. The similarity metric (cosine similarity score) between two normalized vectors is the dot product:
sim(\sqrt{v}₁, \sqrt{v}₂)=\sqrt{v}₁·\sqrt{v}₂=Σᵢ\sqrt{v}₁[i]\sqrt{v}₂[i] (3)
The range of this metric is between −1 and 1.

It should be noted that the aforementioned stop words such as “to,” “a,” “my,” and the like may not be semantically important; however, importance may be task-specific, and words that constitute stop words for one task may have semantic significance for another task. In previous techniques, a human operator with knowledge of both the task and linguistics might be required to make such an assessment. In one or more embodiments of the present invention, model parameters from a discriminative modeling technique such as maximum entropy or the like can be employed to determine if a word is important, unimportant, or counter-evidence to a given class, category, or subcluster.

FIG. 3 shows a flow chart 300 of exemplary detailed method steps that can be used in one or more embodiments of the present invention and can correspond to the seeding process of block 114 in FIG. 1. As indicated at block 302, the feature vectors representing the sentences in a list of sentences may be sorted by frequency, that is, how many times a given sentence appears in the pertinent training corpus. At block 304, pair-wise dot products according to equation (3) above can be computed between every pair of unique normalized feature vectors. Such precomputation can be performed for purposes of efficiency.

Initial centroids can be created as follows. One can fetch the most frequently occurring remaining sentence, as per block 306. Of course, on the first pass through the process, this is simply the most frequent sentence. The sentence can then be compared with all existing centroids in terms of the similarity metric, sim. On the first “pass,” there are no existing centroids, and thus, the first (most frequent) sentence can be designated as a centroid. As indicated in block 310, when the comparison is performed, if the parameter sim is not greater than a given threshold for any existing centroid, then the sentence is not well modeled by any existing centroid, and a new centroid should be created using the vector represented by the given sentence, as indicated at block 312. Where the sentence is well represented by an existing centroid, no new centroid need be created, as indicated at the “Y” branch of decision block 310. Any appropriate value for the threshold that yields suitable results can be employed; at present, it is believed that a value of approximately 0.6 is appropriate in one or more applications of the present invention. As indicated at block 314, one can loop through the process until all the sentences have been appropriately examined to see if they should correspond to new centroids that should be created.

It is presently believed that the seeding procedure just described is preferable in one or more embodiments of the present invention, and that it will provide better results than (traditional) K-means procedures where an original model is split in two portions, one with a positive peturbation and one with a negative peturbation. The seeding process described herein is believed to converge relatively quickly.

FIG. 4 shows a flow chart 400 depicting exemplary method steps in an inventive K-means procedure corresponding to blocks 116-120 of FIG. 1. It will be appreciated that algorithms other than the K-means algorithm can also be employed. As indicated at block 402, each sentence is assigned to the most similar centroid according to an appropriate similarity or distance metric (for example, the sim parameter described above). As indicated at block 404, the assignment proceeds until all the sentences have been assigned. As shown at block 406, an average distortion measure can be computed which indicates how well the centroids represent the members of the corresponding subclusters. One can use the average similarity metric over all sentences. As indicated at block 408, one can continue to loop through the process until an appropriate criteria is satisfied. For example, the criteria can be that the change in the distortion measure between subsequent iterations is less than some given threshold. In this case, one must of course perform at least two iterations in order to have a difference to compare to the threshold. Where the change in distortion is not less than the desired threshold, one can proceed to block 412 and compute a new centroid vector for each subcluster, and then loop back through the process just described. The threshold can be determined empirically; it has been found that any small non-zero value is satisfactory, as convergence, with essentially zero change between subsequent iterations, tends to occur fairly quickly.

The computation of block 412 can be performed according to the following equation:
\vec{C}(k)=(Σᵥ_{ⱼ}_{εcluster(k)}\hat{v}ⱼ)/Nₖ, (4)
for the k^{th} cluster, having Nₖ members, where:
vⱼ is the j^{th} feature vector in said cluster, and \hat{v}ⱼ is a corresponding normalized feature vector to said j^{th} feature vector in said cluster.

When the loop is reentered after step 412, the sentences (feature vectors) are then reassigned to the closest of the newly calculated centroids and the new distortion measure is calculated. Once the change in distortion measure is less than the threshold, per block 408, one can proceed to block 410 where one can optionally delete and/or merge subclusters that have fewer than a certain number of vectors or that are too similar. For example, one might choose to delete or merge subclusters that had fewer than five vectors, and one might choose to merge subclusters that were too similar, for example, where the similarity was greater than 0.8. When subclusters are merged, the distortion measure may degrade, such that it may be desirable to reset the base distortion measure. Members of the deleted subclusters can be re-assigned to the closest un-deleted centroids.

It will be appreciated that one goal of the aforementioned process is to make each subcluster more homogeneous. Thus, one looks for competing subclusters, that is, two subclusters that are similar. Further, one examines for subclusters that have too many different heterogeneous items in them. Such comparison of subclusters is typically conducted across classes, that is, one sees if a subcluster in a first class is similar to a subcluster in a second, different class or category. Competing subclusters may be flagged for analysis and need not always be merged. One response would be to move the subclusters between the classes.

FIG. 5 presents a flow chart 500 representative of detailed analysis steps that can correspond to blocks 122 and 124 of FIG. 1, in one or more exemplary embodiments of the present invention. After the data within each class has been clustered, each subcluster within each class can be represented by one of the aforementioned centroid vectors. As shown as block 502, one can compute the pair-wise similarity metrics between centroid vectors across classes. The similarity metric can be given by equation (3) above. Where the similarity metric is greater than some threshold, for example, 0.7, one can flag the pair as a possible confusion/competing pair. This comparison and flagging is indicated at blocks 504, 506. By way of example, subcluster three of class one might be very similar to subcluster seven of class four, and flagging could take place. The flagged pairs may then be highlighted, for example, using a graphical user interface (GUI) to be discussed below, as depicted at block 508. Potential confusion can be handled as follows, optionally using the GUI to examine the data. It may be determined that, for example, cluster seven of class four was labeled incorrectly. Thus, as indicated at block 510, the confusion/competing pair can be examined for incorrect labeling. If this is the case, all the data in subcluster seven of class four could be assigned to class one in a single step, as indicated at block 512. Thus, in one or more embodiments of the present invention, such reassignment can be accomplished without laboriously re-assigning individual sentences. It will be appreciated that the foregoing operations can be performed by a software program with, for example, input from an application developer or other user.

As noted, inconsistent subclusters can be re-assigned completely to the correct subcluster. However, it will appreciated that such re-assignment could also take place for less than all the sentences in the subcluster; for example, the subcluster to be reassigned could be broken up into two or more groups of sentences, some or all of which could be moved to one or more other subclusters (or some could be retained).

As indicated at blocks 514, 516, it may be that the confusion between the subclusters is inherent in the application. In such case, a disambiguation dialog may be developed as described above. Where no incorrect labeling is detected, no reassignment need be performed; further, where no confusion is detected, no disambiguation need be performed. This is indicated by the “NO” branches of decision blocks 510, 514 respectively. Yet further, where the similarity metric does not exceed the threshold in block 504, the aforementioned analyses can be bypassed. One can then determine, per block 518, whether all pairs have been analyzed; if not, one can loop back to the point prior to block 504. If all pairs have been analyzed, one can proceed to block 520, and determine whether the number of conflicts detected exceeds a certain threshold. This threshold is best determined empirically by investigating whether performance is satisfactory, and if not, applying a more stringent value. If the threshold is not exceeded, one can output the model as at block 522. If the threshold is exceeded, meaning that too many conflicts were detected, as indicated at item A, one can proceed back to the corresponding location in FIG. 2 and perform further iterations to refine the model.

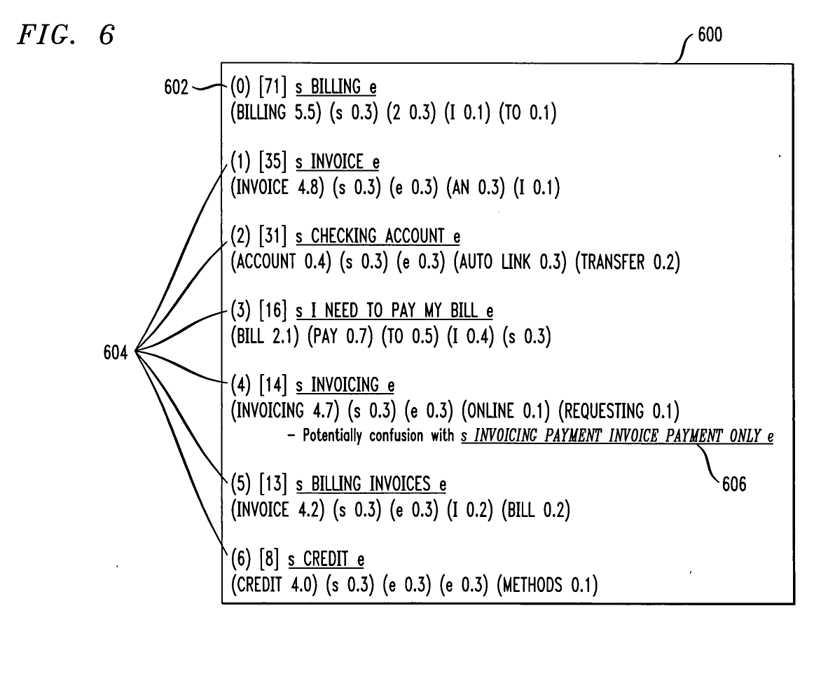

With regard to the aforementioned disambiguation dialog and block 516, consider again the example wherein a caller or other user makes the utterance “delivery on Saturday.” An appropriate disambiguation dialog might be “are you expecting a delivery for something you have ordered, or are you inquiring whether we can deliver on a particular date?” A first response from a caller might be: “if I order the sweater today, will you be able to deliver on Saturday?” A system according to one or more aspects of the present invention could then respond “Okay, let me check the information. Due to the holiday shipping season, delivery can take up to 5 business days. However, if you ship by express, you can expect delivery within a day.” A second caller, who intended a different meaning, might respond to the disambiguation dialog as follows: “my gift was supposed to arrive on Saturday but it has not.” A system according to one or more embodiments of the present invention might then respond “Okay, I can help you with that. Can you give me your order number or zip code?”FIG. 6 shows an exemplary display 600 that can be produced by a GUI tool in accordance with an aspect of the present invention. By way of example, there might be two main categories, for example, BILLING 602 and ONLINE SERVICES (not shown in FIG. 6). FIG. 6 is representative of various subclusters 604 under the BILLING category; for example, subcluster one is INVOICE, subcluster two is CHECKING ACCOUNT, and the like. The numbers enclosed in square brackets indicate the number of sentences in the category or subcluster. An “s” denotes start while an “e” denotes end. In the example of FIG. 6, a data anomaly, such as an inconsistency or ambiguity, is detected with regard to subcluster four. More specifically, subcluster four is found to compete with subclusters denoted as “INVOICING PAYMENT” and “INVOICE PAYMENT ONLY.” Using the graphical user interface, one can select subcluster four, for example, by means of a mouse click on link 606 or a similar human-computer interaction. This can result in display of information to be discussed below with regard to FIG. 7. The second line for each entry represents a point in high vector space with the terms weighted by weighting factors. It can be determined, for example, by picking a certain number of the most significant terms from equation 4 (approximating \vec{C}(k) by picking the five most significant terms has been found to be suitable in practice).

FIG. 7 provides details of a display 700 responsive to the detected competing subcluster “INVOICING PAYMENT.” A number of concepts are contained within this subcluster, for example, three sentences (refer to numbers in square brackets) regarding INVOICING, two sentences regarding help with INVOICING PAYMENT, and one sentence each with ONLINE INVOICING, INVOICE PAYMENT ONLINE, and VOICING INVOICING HELP. The second line for each entry provides information similar to that provided in FIG. 6.

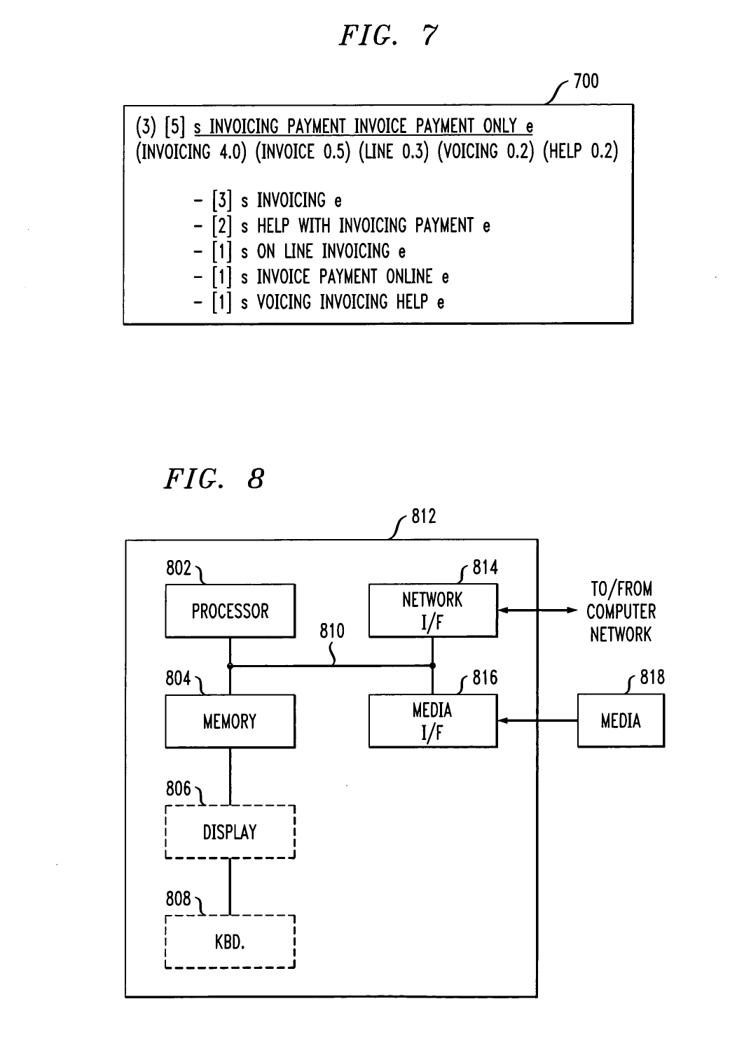

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. With reference to FIG. 8, such alternate implementations might employ, for example, a processor 802, a memory 804, and an input/output interface formed, for example, by a display 806 and a keyboard 808. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (e.g., hard drive), a removable memory device (e.g., diskette), a flash memory and the like. In addition, the phrase “input/output interface” as used herein, is intended to include, for example, one or more mechanisms for inputting data to the processing unit (e.g., mouse), and one or more mechanisms for providing results associated with the processing unit (e.g., printer). The processor 802, memory 804, and input/output interface such as display 806 and keyboard 808 can be interconnected, for example, via bus 810 as part of a data processing unit 812. Suitable interconnections, for example via bus 810, can also be provided to a network interface 814, such as a network card, which can be provided to interface with a computer network, and to a media interface 816, such as a diskette or CD-ROM drive, which can be provided to interface with media 818.

Accordingly, computer software including instructions or code for performing the methodologies of the invention, as described herein, may be stored in one or more of the associated memory devices (e.g., ROM, fixed or removable memory) and, when ready to be utilized, loaded in part or in whole (e.g., into RAM) and executed by a CPU. Such software could include, but is not limited to, firmware, resident software, microcode, and the like.

Furthermore, the invention can take the form of a computer program product accessible from a computer-usable or computer-readable medium (e.g., media 818) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (e.g. memory 804), magnetic tape, a removable computer diskette (e.g. media 818), a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 802 coupled directly or indirectly to memory elements 804 through a system bus 810. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 808, displays 806, pointing devices, and the like) can be coupled to the system either directly (such as via bus 810) or through intervening I/O controllers (omitted for clarity).

Network adapters such as network interface 814 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, e.g., application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer-implemented method of detecting data anomalies in a natural language understanding (NLU) system, comprising the steps of:
obtaining a plurality of categorized sentences that are categorized into a plurality of categories;
clustering those of said sentences within a given one of said categories into a plurality of subclusters; and
analyzing said subclusters to identify data anomalies therein.

2. The method of claim 1, wherein said clustering is based on surface forms of said sentences.

3. The method of claim 1, wherein said data anomalies comprise data ambiguities.

4. The method of claim 1, wherein said clustering comprises clustering with a K-means clustering algorithm.

5. The method of claim 1, wherein said subclusters have centroids and said analyzing step comprises determining at least one parameter associated with pairs of said centroids for selected ones of said subclusters falling into different ones of said categories.

6. The method of claim 5, wherein said categorized sentences have features and are represented as feature vectors that are normalized into normalized feature vectors, and wherein said at least one parameter comprises a similarity metric given by:
sim(\sqrt{v}₁, \sqrt{v}₂)=\sqrt{v}₁·\sqrt{v}₂=Σᵢ\sqrt{v}₁[i]\sqrt{v}₂[i]
where the i^{th} normalized feature vector is given by: \vec{v}[i]=v′[i]/∥v′∥, with ∥v′∥=\sqrt{Σᵢv′[i]²}, and where, for each sentence with corresponding class label cₖ, for each given one of said features fᵢ, v′[i]=v[i]λ(fᵢ, cₖ), where λ(fᵢ, cₖ) is a feature/class pair.

7. The method of claim 1, wherein said categorized sentences are categorized according to a categorization model and said analyzing step comprises:
applying said categorization model to sentences within a given one of said subclusters to obtain model results; and
analyzing said model results to detect the presence of at least one of conflicting labeling and potentially incorrect labeling.

8. The method of claim 1, wherein at least some of said subclusters are represented by a canonical sentence.

9. The method of claim 1, wherein at least some of said subclusters are represented by a centroid comprising important words with weights.

10. The method of claim 9, wherein said categorized sentences are represented as feature vectors, and wherein said centroids are represented by centroid vectors in the form:
\vec{C}(k)=(Σᵥ_{ⱼ}_{εcluster(k)}\hat{v}ⱼ)/Nₖ,
for the k^{th} cluster, having Nₖ members, where:
vⱼ is the j^{th} feature vector in said cluster, and is a corresponding normalized feature vector to said j^{th} feature vector in said cluster.

11. The method of claim 1, further comprising the additional step of relabeling selected ones of said sentences, on a subcluster basis as opposed to a sentence-by-sentence basis, responsive to identification of said data anomalies.

12. The method of claim 11, wherein said data anomalies comprise data inconsistencies.

13. The method of claim 1, wherein said clustering step comprises the sub-steps of:
checking a given number of said sentences that have been clustered into a given one of said subclusters against a quantity criteria; and
reassigning said given number of said sentences to another given one of said subclusters responsive to said checking against said quantity criteria.

14. The method of claim 1, wherein said clustering step comprises the sub-steps of:
modeling each of said sentences as a feature vector; and
creating a new centroid model for those of said feature vectors that differ, by more than a specified amount, from any existing centroid models.

15. The method of claim 1, wherein a first portion of said sentences fall within a first one of said classes and a second portion of said sentences, having surface forms similar to surface forms of said first portion of said sentences, fall within a second one of those classes, further comprising the additional steps of:
forming a new set for said first and second portions of said sentences; and
obtaining data representative of a disambiguation dialog suitable for disambiguating between said first and second portions of said sentences.

16. The method of claim 15, wherein said obtaining step comprises:
prompting a user to construct said disambiguation dialog; and
receiving said data from said user.

17. The method of claim 1, wherein said clustering step comprises the sub-steps of:
assigning each of said sentences to a pre-existing centroid corresponding to a given subcluster;
computing a distortion measure; and
responsive to a change in said distortion measure being at least equal to a threshold value, conducting an additional iteration of said assigning and computing steps.

18. A computer program product comprising a computer usable medium having computer usable program code for detecting data anomalies in a natural language understanding (NLU) system, said computer program product including:
computer usable program code for obtaining a plurality of categorized sentences that are categorized into a plurality of categories;
computer usable program code for clustering those of said sentences within a given one of said categories into a plurality of subclusters; and
computer usable program code for analyzing said subclusters to identify data anomalies therein.

19. The computer program product of claim 18, wherein said clustering is based on surface forms of said sentences.

20. An apparatus for detecting data anomalies in a natural language understanding (NLU) system, comprising:
a memory; and
at least one processor coupled to said memory and operative to:
obtain a plurality of categorized sentences that are categorized into a plurality of categories;
cluster those of said sentences within a given one of said categories into a plurality of subclusters; and
analyze said subclusters to identify data anomalies therein.
